(19) United States
(12) Patent Application Publication
(10) Pub. No.: US 2024/0085711 A1
(43) Pub. Date: Mar. 14, 2024

(54) OPTICAL ARRAY PANEL TRANSLATION

(71) Applicant: Microsoft Technology Licensing, LLC, Redmond, WA (US)

(72) Inventor: Long YANG, Espoo (FI)

(73) Assignee: Microsoft Technology Licensing, LLC, Redmond, WA (US)

(21) Appl. No.: 17/932,190

(22) Filed: Sep. 14, 2022

(51) Int. Cl. G02B 27/01

(52) U.S. Cl. CPC G02B 27/0179; G02B 27/0172; G02B 27/0176; G02B 2027/0159; G02B 2027/0178; G02B 2027/0187

(57) ABSTRACT

A head-wearable display device includes a display panel to emit display light. An optical array panel is positioned along an optical path of the display light emitted by the display panel, and configured to redirect the display light toward an eyebox. An eye tracking system estimates a current pupil position of a user eye relative to the head-wearable display device. An actuator translates a position of the optical array panel relative to the display panel to move a position of the eyebox toward the current pupil position of the user eye.

### BACKGROUND

Head-wearable display devices can be used to present computer-generated images to a user's eyes and thereby provide mixed reality experiences—e.g., augmented and/or virtual reality experiences. Some head-wearable display devices use waveguides to propagate display light from a light source toward an eyebox at which the imagery is viewable by the user. However, use of waveguide-based designs can result in relatively bulky devices with low power efficiency.

### BRIEF DESCRIPTION OF THE DRAWINGS

FIG. 1 schematically illustrates use of an example head-wearable display device.

FIG. 2 schematically shows an example head-wearable display device.

FIG. 3 illustrates an example method for a head-wearable display device.

FIGS. 4A-4D schematically illustrate operation of an example display assembly of a head-wearable display device.

FIG. 5 schematically illustrates operation of another example display assembly of a head-wearable display device.

FIGS. 6A-6C schematically illustrate use of an optical array panel to redirect display light.

FIG. 7 schematically shows an example computing system.

### DETAILED DESCRIPTION

Use of waveguide-based optical systems in head-wearable display devices, as well as other display devices having non-wearable form factors, can result in relatively bulky devices with low power efficiency. For instance, such waveguide-based approaches often generate relatively large “eyeboxes,” referring to a region of space in which the display image is viewable by a human eye. However, the user's eye pupil is typically much smaller than the size of the eyebox, meaning that at any given moment, only a small portion of the eyebox is used to view the display image. This can result in relatively large amounts of wasted display light, and can have negative repercussions for device power consumption, often requiring a relatively larger on-board battery to compensate. Furthermore, the display image will generally have a global uniform sharpness within the entire eyebox. This can be disorienting for the user, as it differs from how the user typically perceives their real-world surroundings—e.g., a region of sharp focus provided by the eye's fovea, surrounded by a relatively unfocused peripheral visual field.

Accordingly, the present disclosure is directed to a design for an optical system that can beneficially generate a relatively smaller eyebox that dynamically follows the user's pupil position, enabling an overall reduction in device size and power consumption. Specifically, according to the present disclosure, a head-wearable display device includes a display panel that emits display light to present a display image. An optical array panel positioned along an optical path of the display light redirects the display light toward an eyebox for viewing. In some cases, the display light is emitted away from the user eye, and reflected back toward the user eye by the optical array panel. The head-wearable display device further includes an eye tracking system to estimate a current pupil position of the user eye relative to the head-wearable display device. Based on the current pupil position, an actuator is used to translate a position of the optical array panel relative to the display panel. This has the effect of moving the position of the eyebox toward the current pupil position of the user eye—e.g., causing the eyebox to dynamically follow the user's eye movements.

In this manner, the head-wearable display device forms a relatively smaller eyebox that dynamically follows the position of the user eye pupil. This beneficially reduces power consumption of the device, as less overall display light is used to form the relatively smaller eyebox. Furthermore, the techniques described herein can beneficially reduce the physical size of the head-wearable display device, as compared to relatively more bulky approaches that include waveguide combiners. While the present disclosure primarily focuses on head-wearable display devices, it will be understood that the techniques described herein can be used with any suitable display device used to present display images to a user eye.

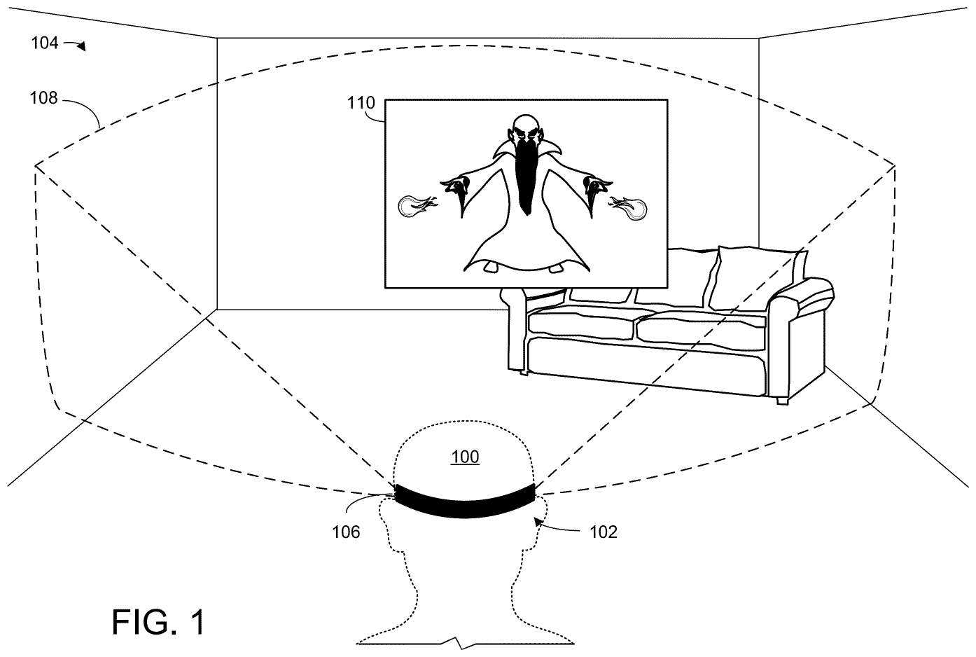

FIG. 1 schematically illustrates use of a head-wearable display device. Specifically, FIG. 1 schematically depicts a user 100 wearing a head-wearable display device 102 and viewing a surrounding real-world environment 104. Head-wearable display device 102 includes one or more near-eye displays 106 configured to present computer-generated imagery to eyes of the user, as will be described below. Such computer-generated imagery is also referred to herein as “display images.” FIG. 1 also shows a field of view (FOV) 108 indicating an area in which the near-eye displays can present display images that will be visible to the user.

Head-wearable display device 102 is useable to view and interact with computer-generated display images. In the example of FIG. 1, the head-wearable display device is presenting a display image 110, taking the form of a virtual wizard character that is not present in the user's real-world environment. Such virtual imagery is presented via the near-eye displays as a series of digital image frames that dynamically update over time—e.g., based on changes in an underlying software application, and/or as a position/orientation of the head-wearable display device changes.

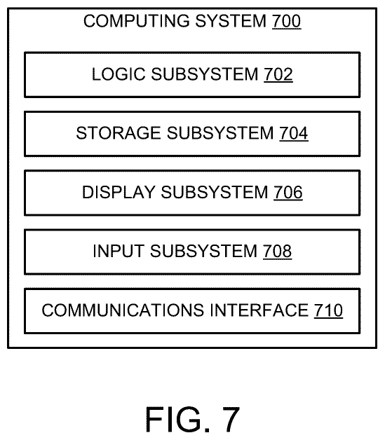

Display images presented by the head-wearable display device can be rendered by any suitable computer logic componentry. In some examples, such logic componentry is on-board. Additionally, or alternatively, at least some rendering of display images is outsourced to an off-board computing device—e.g., collocated in a same real-world environment as the head-wearable display device, or streamed over a suitable computer network. In general, the computer logic componentry that renders the display images can have any suitable capabilities, hardware configuration, and form factor. In some cases, such logic componentry is implemented as a logic machine as described below with respect to FIG. 7. In some cases, the head-wearable display device is implemented as computing system 700 shown in FIG. 7.

In some examples, the head-wearable display device is an augmented reality computing device that allows user 100 to directly view real world environment 104 through near-eye displays that are at least partially transparent. Alternatively, in other examples, the near-eye displays are fully opaque and either present imagery of a real-world environment as captured by a front-facing camera, or present a fully virtual surrounding environment while blocking the user's view of the real world. To avoid repetition, experiences provided by both implementations are referred to as presenting display images to a user's eye(s), regardless of whether any portion of the surrounding real-world environment is also visible to the user.

As discussed above, example implementations of the head-wearable display device produce display images via two near-eye displays, one for each user eye. By presenting left and right images at respective left and right near-eye displays, the head-wearable display device creates the cognitive impression that the two images correspond to a single three-dimensional virtual object. By controlling the sizes and positions of the left and right display images, the head-wearable display device can control the world-space position that the virtual object appears to occupy (e.g., the object's apparent three-dimensional position relative to the user). In other examples, however, a head-wearable display device only includes one near-eye display, or more than two near-eye displays, and presents display images to either or both of a user's eyes.

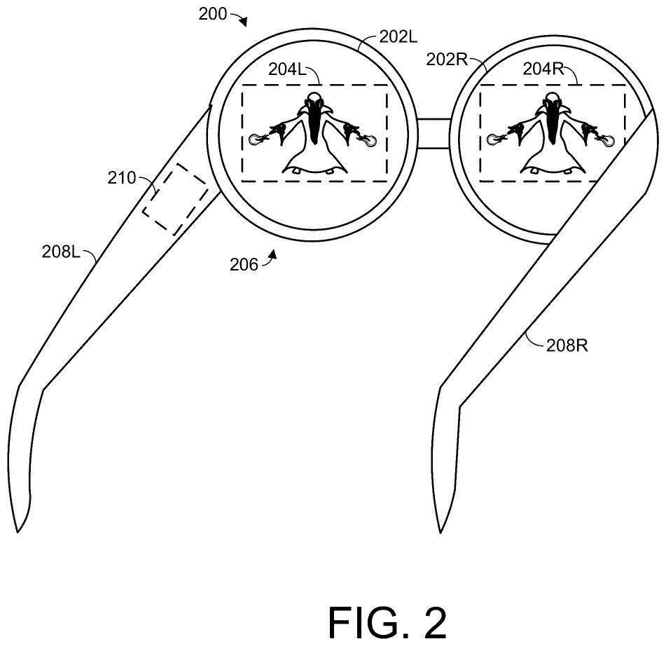

FIG. 2 schematically illustrates an example head-wearable display device 200. It will be understood that the specific appearance and physical configuration of head-wearable display device 200 are greatly simplified for ease of understanding and are in no way limiting. In general, the techniques and structures described herein are useable with a wide variety of different suitable devices, which may differ from head-wearable display device 200 in any number of suitable ways.

As shown, head-wearable display device 200 includes a left display assembly 202L and a right display assembly 202R, each of which constitute “near-eye displays” as described above. As will be described in more detail below, a “display assembly” includes a display panel cooperating with an optical array panel to direct display light toward an eyebox. The left display assembly is configured to provide left-side display light, useable to form a left display image for viewing by a user's left eye at an eyebox of the left display assembly. Similarly, the right display assembly is configured to provide right-side display light, useable to form a right display image for viewing by the user's right eye at an eyebox of the right display assembly. In FIG. 2, the left and right display assemblies are forming left- and right-side images 204L and 204R, taking the form of the virtual wizard character shown in FIG. 1.

In the example of FIG. 2, the left and right display assemblies are generally circular in shape. It will be understood that this is a non-limiting example. In general, each display assembly can have any suitable regular or irregular shape, provided that they are each useable for delivering display light to an eyebox for viewing by a user eye. Furthermore, the left and right display assemblies need not each have the same shape.

In the example of FIG. 2, the head-wearable display device includes a wearable frame assembly 206 sized and shaped for wearing on a human head. As shown, the wearable frame assembly includes circular frames surrounding left display assembly 202L and right display assembly 202R. The wearable frame assembly also includes a left temple support arm 208L and a right temple support arm 208R. Thus, in this example, the wearable frame assembly is similar to the frame of a conventional pair of eyeglasses—e.g., two separate temple supports that, when worn, support the head-wearable display device through contact with the user's temples and/or ears. In other words, the display assemblies, including respective display panels and optical array panels, are coupled to the wearable frame assembly for wearing on a human head. This beneficially reduces the burden of user input to the computing device, providing a familiar and comfortable form factor through which the user can view and interact with computer-generated imagery.

However, as discussed above, it will be understood that the specific configuration of head-wearable display device 200 shown in FIG. 2 is non-limiting and serves as only one simplified example. In other examples, the wearable frame assembly takes other suitable forms—e.g., the wearable frame assembly may include a headband that wraps around the wearer's head, rather than two separate temple supports, or the wearable frame assembly may include a helmet supporting a display with a visor form factor.

Display of computer-generated imagery by the left and right display assemblies is controlled by a suitable image source. In FIG. 2, an example image source 210 is schematically represented within left temple support arm 208L. It will be understood that the specific position of the image source respect to the rest of head-wearable display device 200 is not limiting, and is used only for the sake of example.

The image source takes the form of any suitable computer logic componentry, such as a suitable processor or application-specific integrated circuit (ASIC). As one example, image source 210 is implemented as logic machine 702 described below with respect to FIG. 7. The image source renders display images for presentation by the near-eye displays. In some examples, the image source also sends control inputs to the respective display assemblies, causing the display assemblies to provide spatially-modulated display light and thereby present the display images for viewing. In other examples, specific control over the display assemblies is delegated to one or more display controllers. For instance, the image source may output a rendered display image frame, and a separate display controller performs the steps of translating the rendered image frame into control inputs that cause output of spatially-modulated display light to present the display image for viewing.

In other examples, the display assemblies are used to display images originating from a source other than image source 210. For example, as discussed above, at least some display images presented by the display assemblies can be rendered by an offboard device—e.g., streamed over a computer network such as the Internet.

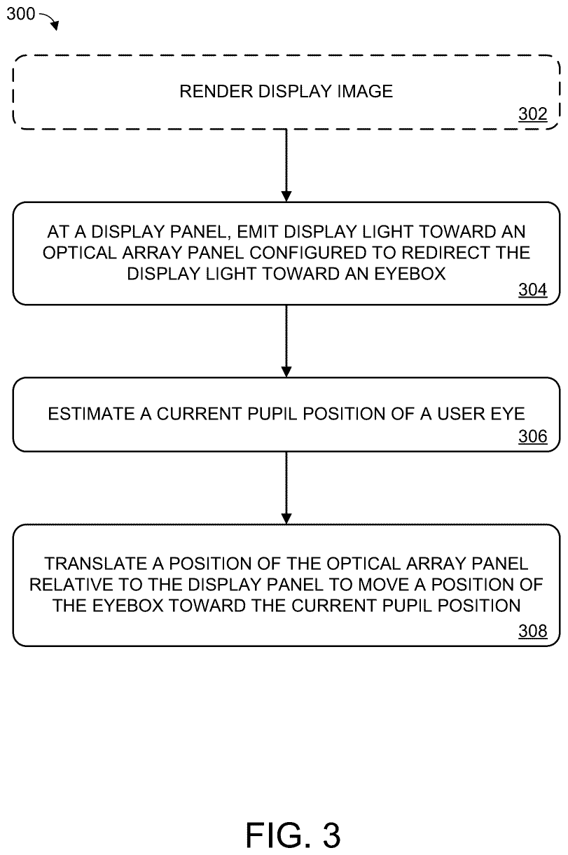

FIG. 3 illustrates an example method 300 for a head-wearable display device. The present disclosure primarily focuses on examples where steps of method 300 are performed by on-board processing componentry of the head-wearable display device—e.g., by image source 210 of head-wearable display device 200. In other examples, however, any or all steps of method 300 are performed by offboard processing components. In further examples, method 300 is performed by display devices having non-wearable form factors. In general, method 300 may be implemented by any suitable computing device having any suitable capabilities, form factor, and hardware configuration. As one example, method 300 may be performed by computing system 700 described below with respect to FIG. 7.

At 302, method 300 optionally includes rendering a display image for presentation to a user eye via the head-wearable display device. As discussed above with respect to FIG. 2, the image source is implemented in various examples as any suitable computer logic componentry, such as a suitable processor or application-specific integrated circuit (ASIC). As one example, image source 210 is implemented as logic machine 702 described below with respect to FIG. 7.

A display image generally takes the form of any suitable visual content that is presented for display during use of the head-wearable display device. For instance, the display image can take the form of virtual objects or characters presented as part of a game or simulation (such as the virtual wizard character shown in FIG. 1), annotations or augmentations highlighting real-world objects (e.g., labels, nametags), user interface elements (such as menus, dialog boxes), etc. It will be understood that the techniques described herein are applicable to presentation of any suitable type of display images, regardless of the specific contents of such display images.

Furthermore, it will be understood that the display images presented by the head-wearable display device need not be rendered at runtime by the head-wearable display device. For instance, the display image may be a prerendered image or a frame of a prerendered video. In some examples, the display image may be rendered by a separate computing device and streamed to the head-wearable display device—e.g., over a suitable computer network such as the Internet. In general, the present disclosure focuses on techniques for presenting display images, without regard to the actual source or content of such display images.

Continuing with FIG. 3, at 304, method 300 includes, at a display panel of the head-wearable display device, emitting display light toward an optical array panel. The optical array panel is configured to redirect the display light toward an eyebox at which the display image is viewable by a user eye.

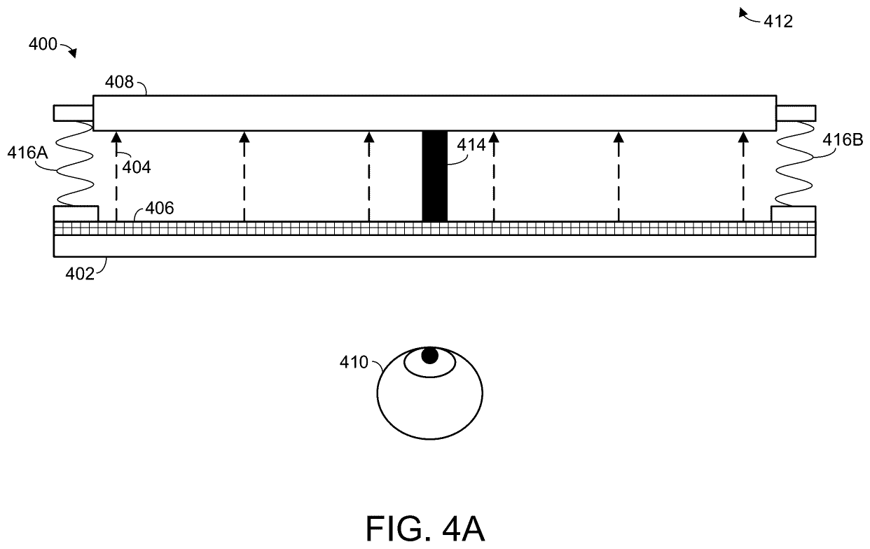

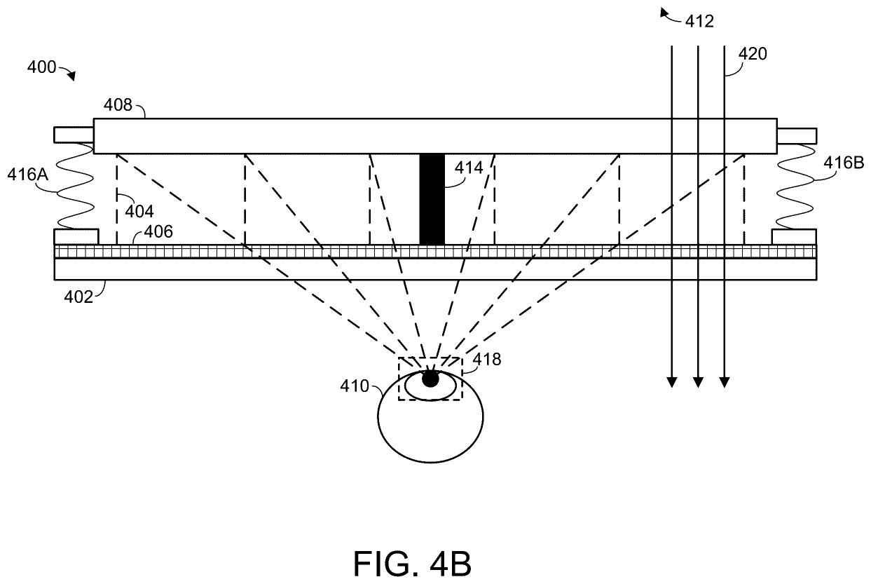

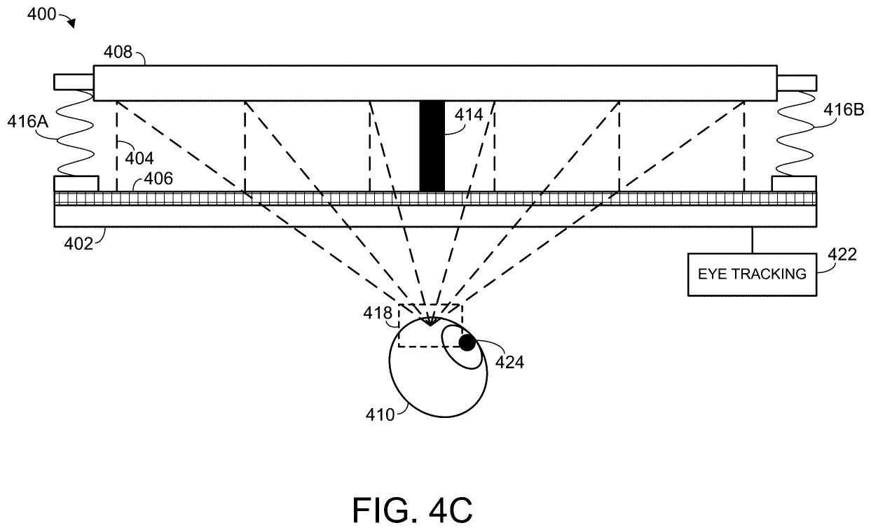

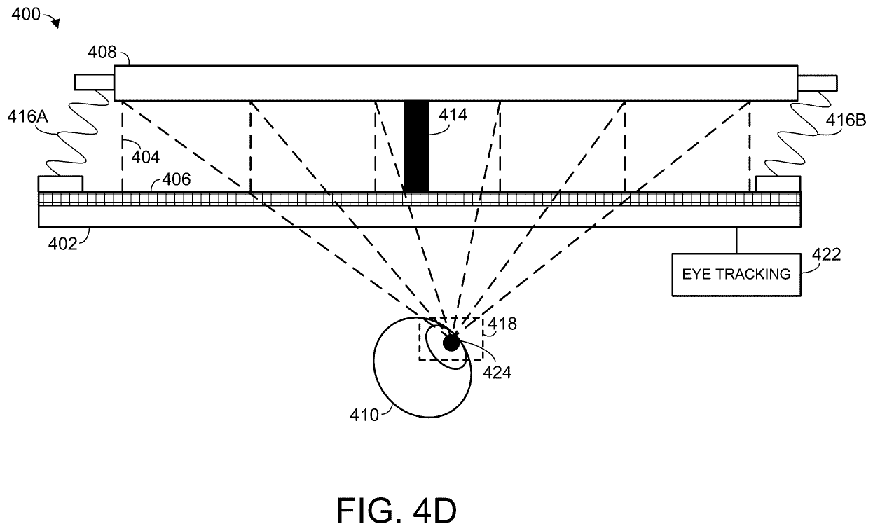

This is schematically illustrated with respect to FIG. 4A. Specifically, FIG. 4A schematically shows an example display assembly 400 of a head-wearable display device. The display assembly includes a display panel 402 to emit display light 404 and thereby present a display image for viewing.

The display panel can include any suitable image forming technology for providing spatially-modulated display light. In some examples, the display panel includes a plurality of emissive display pixels to emit the display light. This is schematically illustrated in FIG. 4A, in which display panel 402 includes a plurality of emissive display pixels 406. As one non-limiting example, the plurality of display pixels are implemented as part of a micro-organic light emitting diode (μOLED) display of the display panel. Use of such an emissive display technology provides a technical benefit of improving display contrast and clarity while reducing overall power consumption as compared to other display technologies.

It will be understood, however, that other suitable emissive and/or transmissive display technologies may additionally or alternatively be used. For example, in some cases, the image source and light source may be separate—e.g., the display panel serves as a light source, while the head-wearable display device includes one or more additional optical elements to spatially modulate the light provided by the display panel and thereby form the display image.

In some examples, the display panel is at least partially transparent to light originating from the surrounding real-world environment. In one non-limiting embodiment, indium tin oxide (ITO) is used as a material in constructing a transparent display panel. Any non-transparent electrical traces or wires may beneficially be positioned such that they are not typically visible to a user during normal operation. It will be understood, however, that any suitable materials can be used to construct the display panel. As will be described in more detail below, in some examples the display panel is substantially opaque to light originating from the real-world environment.

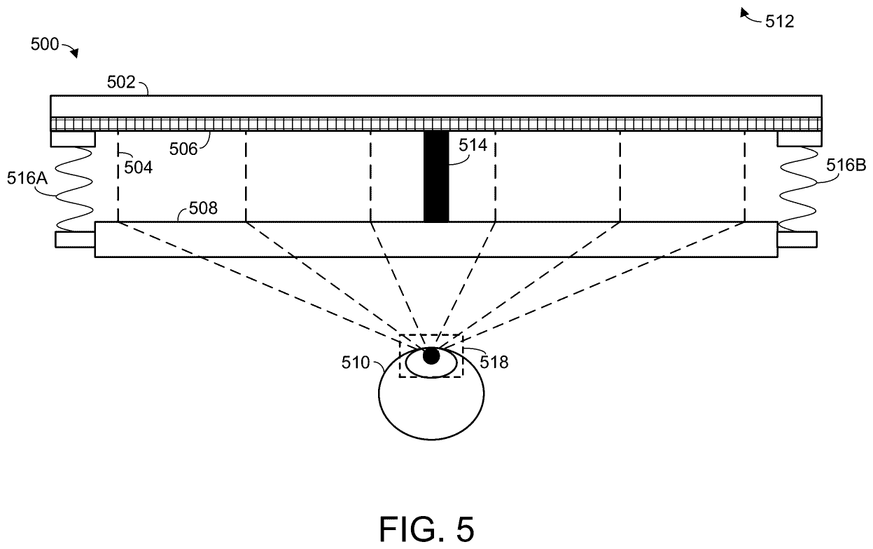

In FIG. 4A, the display light is emitted toward an optical array panel 408. As will be described in more detail below, the optical array panel redirects the display light toward an eyebox for viewing by a user eye 410. In this example, the display panel emits the display light away from the user eye and toward a surrounding real-world environment 412. In other words, the display panel is positioned between the user eye and the optical array panel. An alternate example display assembly configuration will be described below with respect to FIG. 5, in which the optical array panel is positioned between the user eye and display panel.

In FIG. 4A, the display assembly further comprises a spacer 414 disposed between the display panel and the optical array panel. The spacer separates the display panel and the optical array panel by a predetermined separation distance. In various examples, different suitable separation distances are used depending on the specific display and optical technologies used and the overall size of the head-wearable display device. Although only one spacer is shown in FIG. 4A, any suitable number of individual spacers may be used depending on the implementation.

In some examples, the spacer is fabricated on the display panel. In other examples, the spacer is fabricated on the optical array panel. In cases where the optical array panel utilizes a micromirror array, as will be described in more detail below, then one example location for the spacer is in the vicinity of the micromirror junction. As one non-limiting example, the spacer is fabricated using a photolithographic process, although other suitable fabrication processes may additionally or alternatively be used.

FIG. 4A additionally schematically shows two actuators 416A and 416B. As will be described in more detail below, an actuator is used to translate a position of the optical array panel relative to the display panel. Although two actuators 416A and 416B are shown in FIG. 4A, this is non-limiting, and different suitable numbers of actuators are used in different implementations. As one non-limiting example, an actuator is implemented as a microelectromechanical (MEMS) actuator. In general, however, any suitable technology may be used for translating the position of the optical array panel relative to the display panel, and/or vice versa.

As discussed above, in the example of FIG. 4A, the display panel emits display light toward the optical array panel. In other words, optical array panel 408 is positioned along an optical path of the display light emitted by the display panel. The optical array panel then redirects the display light toward an eyebox at which it is viewable by the user eye.

This is schematically illustrated with respect to FIG. 4B, again showing display assembly 400. In FIG. 4B, the display light is redirected by the optical array panel toward an eyebox 418. In other words, the display light is reflected by the optical array panel toward the user eye, and the display light passes through the display panel en route to the user eye after reflection by the optical array panel.

In some examples, the display panel and the optical array panel are at least partially transparent to real-world light originating from a surrounding real-world environment. This is schematically illustrated with respect to FIG. 4B, in which real-world light 420 originating from surrounding environment 412 is shown passing through optical array panel 408 and display panel 402. In this manner, the real-world environment remains at least partially visible to the user eye even while display images are presented by the display assembly, thereby providing an augmented reality experience.

In other examples, either or both of the optical array panel and display panel are substantially opaque to the real-world light originating from the surrounding real-world environment. This can be used to provide a virtual reality experience, in which the user's view of the real-world environment is substantially replaced with computer-generated imagery. Additionally, or alternatively, images of the real-world captured by a suitable camera may be presented by the display assembly to retain visibility of the real-world environment even when either or both of the display panel and optical array panel are opaque.

The optical array panel generally takes the form of any suitable optical element or array of optical elements usable to redirect inbound display light in a particular direction. In some implementations, the optical array panel is configured to focus or collimate the display light toward a target location away from the position of the optical array panel, thereby forming an eyebox at which the display light is viewable by a user eye. As such, the position of the eyebox will depend on the position of the optical array panel relative to the display panel. As will be described in more detail below, the position of the eyebox can be changed by translating the position of the optical array panel via one or more actuators—e.g., to dynamically follow movements of the user eye. In some examples, elements of the optical array panel are on the pixel dimension scale.

In some examples, the optical array panel includes a micromirror array. More specifically, in some examples the micromirror array uses a half-mirror design, in which the optical array panel is at least partially transparent to light from the surrounding real-world environment. In other examples, the micromirror array uses a full-mirror design, in which it is substantially opaque to light from the real-world environment. The micromirror array can be fabricated in any suitable way and using any suitable materials. As one non-limiting example, the micromirror array is fabricated using optical resin on a glass substrate.

However, it will be understood that the optical array panel can use other suitable optical elements in addition to, or instead of, a micromirror array. As other non-limiting examples, the optical array panel uses a microlens array, and/or the optical array panel uses a suitable metasurface layer. A microlens array may be implemented by varying one or more of a shape or refractive index along the surface of the substrate. For instance, a microlens array may be implemented as a plurality of micro-Fresnel lenses. A metasurface layer in some examples takes the form of a patterned substrate that affects optical properties of inbound light, where the pattern of the substrate may be on the sub-wavelength scale. Non-limiting materials for metasurface layers include gold antenna arrays disposed on a silicon substrate, and/or dielectric nanoparticles.

In the example of FIG. 4B, the position of eyebox 418 is substantially aligned with the position of the pupil of user eye 410. As such, the display light 404 emitted by display panel 402 is viewable by the user eye as a display image. However, during typical use, the position of the eye pupil relative to the head-wearable display device may change. This can occur when, for example, the position of the entire head-wearable display device changes (e.g., due to movements of the user), and/or due to rotational movement of the user eye to look in a different direction.

As such, returning briefly to FIG. 3, at 306, method 300 includes estimating a current pupil position of the user eye. This is schematically illustrated with respect to FIG. 4C, again showing display assembly 400 and user eye 410. In this example, however, the user eye has rotated to a different gaze direction, changing the position of the eye pupil relative to the eyebox. The head-wearable display device includes an eye tracking system 422 to estimate a current pupil position of the user eye relative to the head-wearable display device. In FIG. 4C, the current pupil position 424 is outside of eyebox 418.

It will be understood that any suitable eye tracking system can be used. As one non-limiting example, the eye tracking system includes a suitable light source to emit light toward the user eye—e.g., infrared light. A suitable light sensor is used to detect light reflecting off the user eye. For example, the system may detect light reflections from the eye cornea (e.g., Purkinje reflections), enabling movements of the eye to be detected, due to the fact that eye movements will also cause movement of the cornea, and therefore movement of the detected positions of the corneal reflections. In general, however, the present disclosure assumes that the head-wearable display device includes suitable functionality for detecting the current pupil position of the user eye, and is agnostic as to the specific eye tracking technology that is used.

Returning briefly to FIG. 3, at 308, method 300 includes translating a position of the optical array panel relative to the display panel. This causes movement of a position of the eyebox toward the current pupil position of the user eye. This process is schematically illustrated with respect to FIG. 4D, again showing display assembly 400 and user eye 410. In this example, actuators 416A and 416B are used to translate the position of the optical array panel, causing corresponding movement of eyebox 418. As shown, the position of the eyebox has changed such that it again includes the current pupil position 424 of the user eye, enabling the user to view the display image corresponding to the emitted display light.

In the example of FIG. 4D, the position of the optical array panel is shifted relative to only one dimension. It will be understood, however, that the optical array panel can have any suitable range of motion, depending on the specific structure of the display assembly and the type of actuators used. In various examples, the optical array panel is moveable in one, two, or three spatial dimensions, enabling dynamic movement of the eyebox to follow various changes in the position of the eye pupil. Furthermore, it will be understood that the optical array panel may in some cases remain stationary while the display panel is moved, and/or both the display panel and optical array panel can each be moved simultaneously.

The present disclosure has thus far focused primarily on an example where the display panel is positioned between the user eye and the optical array panel, and the display light is emitted away from the user eye. However, this need not always be the case. FIG. 5 schematically illustrates a different example display assembly 500, which may provide similar functionality to display assembly 400 described above. However, in this case, the optical panel is positioned between the display panel and the user eye, and the display panel emits the display light toward the user eye, such that the display light passes through the optical array panel en route to the user eye.

More particularly, display assembly 500 includes a display panel 502, which emits display light 504. This may be done via a plurality of emissive display pixels 506 (e.g., implemented as part of a μOLED display), as described above. The display light passes through an optical array panel 508, which redirects the display light toward a user eye 510. In this example, the display light is emitted toward the user eye and away from a surrounding real-world environment 512, in contrast to display assembly 400 described above.

Display assembly 500 additionally includes a spacer 514 and actuators 516A and 516B, each of which may function substantially as described above. For instance, the actuators are used to translate a position of the optical array panel and change the position of an eyebox 518 in which the display light is viewable as a display image—e.g., to dynamically follow eye movements detected by an eye-tracking system. This beneficially results in a smaller eyebox that uses the display light more efficiently, conserving electrical power, while enabling the overall physical size of the head-wearable display device to be reduced as compared to waveguide-based optical solutions.

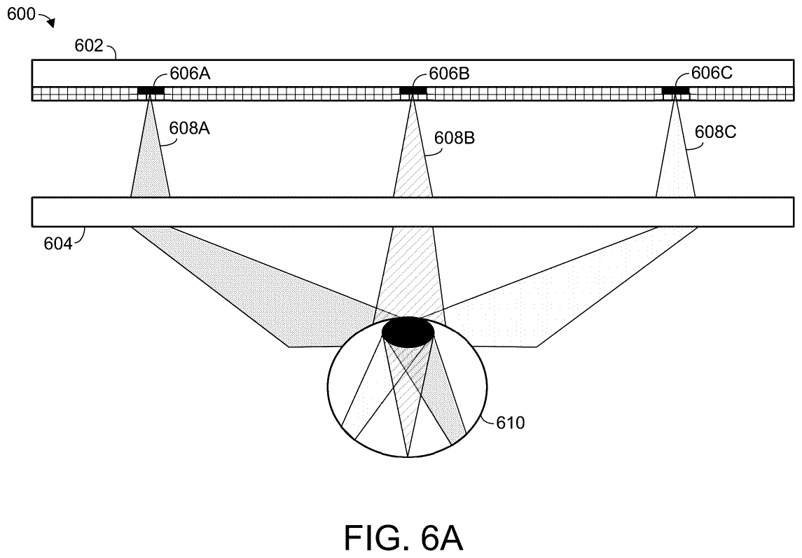

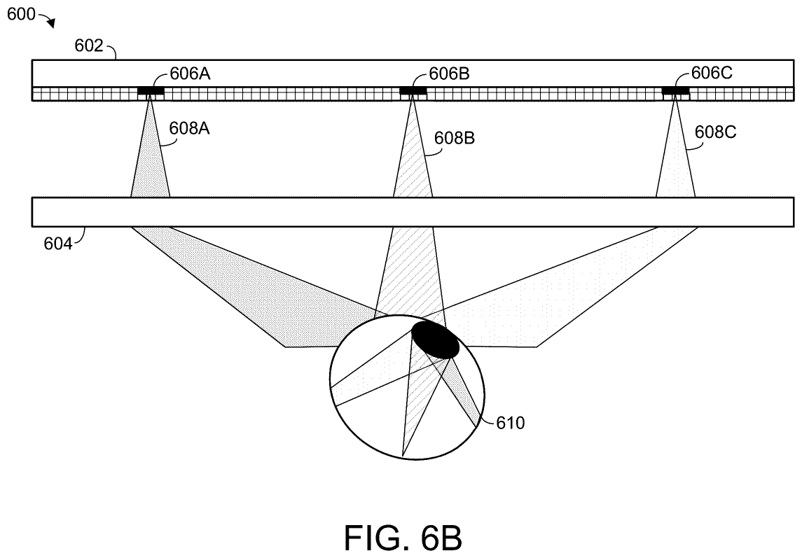

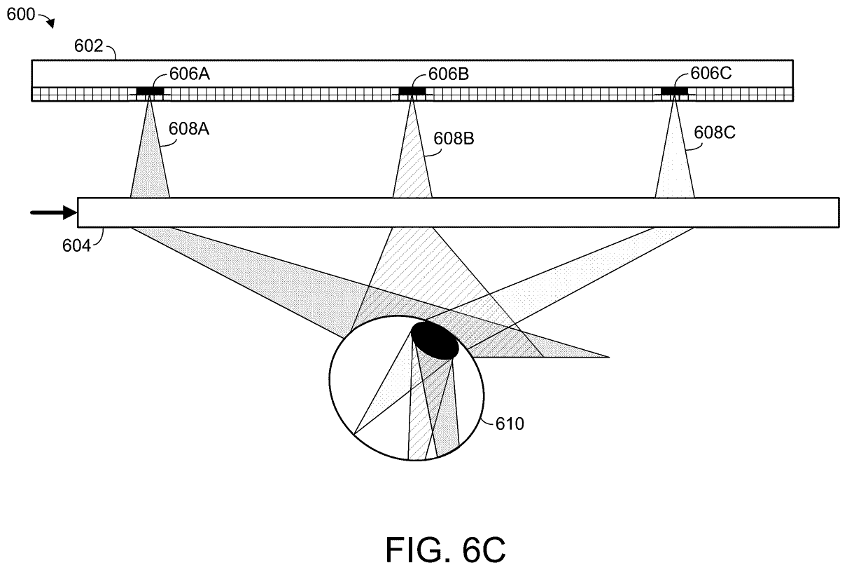

FIGS. 6A-6C schematically illustrate use of an optical array panel to redirect display light in more detail. Specifically, FIG. 6A schematically shows another example display assembly 600, including a display panel 602 and an optical array panel 604. The display panel includes a plurality of pixels configured to emit display light, including pixels 606A, 606B, and 606C schematically shown in FIG. 6A. It will be understood that, in various examples, the display panel includes any suitable number of pixels. Furthermore, it will be understood that display assembly 600 may further include one or more spacers, actuators, eye tracking systems, and/or other components omitted from FIGS. 6A-6C.

In FIG. 6A, pixels 606A-606C are each emitting respective display light 608A-608C. For the sake of clarity, the different sets of display light emitted by the different pixels in FIG. 6A are distinguished from one another using different fill patterns. It will be understood that, in various examples, the display light emitted by any particular pixel has any suitable appearance (e.g., wavelength, intensity), and may differ from display light emitted from other pixels in any suitable way, depending on the content of the display image to be presented. Furthermore, in some cases, some pixels of the display panel are deactivated and not emitting display light.

The sets of display light 608A-608C pass through the optical array panel 604, which redirects the display light toward a user eye 610. In some examples, each pixel of the display panel is paired with a corresponding optical element of the optical array panel. The optical elements of the optical array panel take various suitable forms depending on the specific optical array technology used—e.g., micromirror arrays, microlens arrays, and metasurface layers are suitable non-limiting examples. In general, an optical element is designed in such a way that, for given position of the optical element relative to its corresponding display pixel, it collimates display light of the display pixel toward the center of a user eye.

This is schematically illustrated in FIG. 6A, in which the sets of display light 608A-C are redirected by the optical array panel toward the user eye. For the sake of visual clarity, FIG. 6A is illustrated as though the display light stops propagating forward just beyond the eye pupil. It will be understood that, when emitted by a real display panel, the display light will generally continue propagating away from the optical array panel and through the real-world environment until it ultimately reaches a physical object (e.g., user eye, portions of the user's face or body, or a wall/floor/ceiling). Furthermore, in FIG. 6A, some of the display light enters the user eye via the pupil and eventually reaches the eye retina. As shown, display light 608B is sharply focused on the retina, while display light 608A and 608C are not fully collimated and form blur spots on the eye retina. Thus, in this example, display pixel 606C and its corresponding optical element on the optical array panel are designed to fully collimate display light toward the eye pupil when the pupil is at the center of the user eye, which can be considered the “initial” or “default” pupil position.

FIG. 6B schematically illustrates display panel 600 in a scenario where the user eye has rotated to have a different gaze vector. This affects how the display light emitted by the display panel enters the user eye and forms images on the eye retina. This can in turn create an undesirable visual experience of the user—e.g., the display images presented by the display assembly may have a blurred, doubled, or off-center appearance.

As discussed above, in some examples the head-wearable display device includes an eye-tracking system to estimate the current pupil position of the user eye, and one or more actuators to translate the position of the optical array panel based at least in part on the current pupil position. As such, in FIG. 6C, the position of the optical array panel is shifted in a manner that affects its redirection of display light toward the user eye. Specifically, in FIG. 6C, display light 608C is now fully collimated and forms a focused image on the eye retina. In other words, the display pixel 606C and its corresponding optical element of the optical array panel are designed to fully collimate display light toward the pupil and eye center when the user eye has the position/gaze vector depicted in FIG. 6C. By contrast, in this example, display light 608A and 608B are not fully collimated and form blur spots on the eye retina.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 7 schematically shows a simplified representation of a computing system 700 configured to provide any to all of the compute functionality described herein. Computing system 700 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 700 includes a logic subsystem 702 and a storage subsystem 704. Computing system 700 may optionally include a display subsystem 706, input subsystem 708, communication subsystem 710, and/or other subsystems not shown in FIG. 7.

Logic subsystem 702 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 704 includes one or more physical devices configured to temporarily and/or permanently hold computer information such as data and instructions executable by the logic subsystem. When the storage subsystem includes two or more devices, the devices may be collocated and/or remotely located. Storage subsystem 704 may include volatile, nonvolatile, dynamic, static, read/write, read-only, random-access, sequential-access, location-addressable, file-addressable, and/or content-addressable devices. Storage subsystem 704 may include removable and/or built-in devices. When the logic subsystem executes instructions, the state of storage subsystem 704 may be transformed—e.g., to hold different data.

Aspects of logic subsystem 702 and storage subsystem 704 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 706 may be used to present a visual representation of data held by storage subsystem 704. This visual representation may take the form of a graphical user interface (GUI). Display subsystem 706 may include one or more display devices utilizing virtually any type of technology. In some implementations, display subsystem may include one or more virtual-, augmented-, or mixed reality displays.

When included, input subsystem 708 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 710 may be configured to communicatively couple computing system 700 with one or more other computing devices. Communication subsystem 710 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a head-wearable display device comprises: a display panel to emit display light; an optical array panel positioned along an optical path of the display light emitted by the display panel, the optical array panel configured to redirect the display light toward an eyebox; an eye tracking system to estimate a current pupil position of a user eye relative to the head-wearable display device; and an actuator to translate a position of the optical array panel relative to the display panel to move a position of the eyebox toward the current pupil position of the user eye. In this example or any other example, the display panel and the optical array panel are at least partially transparent to real-world light originating from a surrounding real-world environment. In this example or any other example, the display panel emits the display light away from the user eye and toward a surrounding real-world environment. In this example or any other example, the display panel is positioned between the user eye and the optical array panel, such that the display light is reflected by the optical array panel toward the user eye, and the display light passes through the display panel en route to the user eye after reflection by the optical array panel. In this example or any other example, the optical array panel is positioned between the display panel and the user eye, and the display panel emits the display light toward the user eye, such that the display light passes through the optical array panel en route to the user eye. In this example or any other example, the display panel includes a plurality of emissive display pixels to emit the display light. In this example or any other example, the display panel includes a micro-organic light emitting diode (μOLED) display. In this example or any other example, the optical array panel includes a micromirror array. In this example or any other example, the optical array panel includes a microlens array. In this example or any other example, the optical array panel includes a metasurface layer. In this example or any other example, the actuator is a microelectromechanical system (MEMS) actuator. In this example or any other example, the head-wearable display device further comprises a wearable frame assembly sized and shaped for wearing on a human head, the display panel coupled to the wearable frame assembly, and wherein the wearable frame assembly includes a temple support arm.

In an example, a method for a head-wearable display device comprises: at a display panel of the head-wearable display device, emitting display light toward an optical array panel via a plurality of emissive display pixels of the display panel, the display panel being at least partially transparent to real-world light originating from a surrounding real-world environment, and the optical array panel configured to redirect the display light toward an eyebox; estimating a current pupil position of a user eye relative to the head-wearable display device at an eye tracking system of the head-wearable display device; and translating a position of the optical array panel relative to the display panel to move a position of the eyebox toward the current pupil position of the user eye via an actuator of the head-wearable display device. In this example or any other example, the display panel emits the display light away from the user eye and toward the surrounding real-world environment. In this example or any other example, the display panel is positioned between the user eye and the optical array panel, such that the display light is reflected by the optical array panel toward the user eye, and the display light passes through the display panel en route to the user eye after reflection by the optical array panel. In this example or any other example, the optical array panel is positioned between the display panel and the user eye, and the display panel emits the display light toward the user eye, such that the display light passes through the optical array panel en route to the user eye. In this example or any other example, the display panel includes a micro-organic light emitting diode (μOLED) display. In this example or any other example, the optical array panel includes a micromirror array. In this example or any other example, the actuator is a microelectromechanical system (MEMS) actuator.

In an example, a computing system comprises: an image source to render a display image; a display panel to emit display light and thereby present the display image for viewing; an optical array panel positioned along an optical path of the display light emitted by the display panel, the optical array panel configured to redirect the display light toward an eyebox; a spacer disposed between the display panel and the optical array panel to separate the display panel and the optical array panel by a predetermined separation distance; an eye tracking system to estimate a current pupil position of a user eye relative to the computing system; and an actuator to translate a position of the optical array panel relative to the display panel to move a position of the eyebox toward the current pupil position of the user eye.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A head-wearable display device, comprising:
a display panel to emit display light;
an optical array panel positioned along an optical path of the display light emitted by the display panel, the optical array panel configured to redirect the display light toward an eyebox;
an eye tracking system to estimate a current pupil position of a user eye relative to the head-wearable display device; and
an actuator to translate a position of the optical array panel relative to the display panel to move a position of the eyebox toward the current pupil position of the user eye.

2. The head-wearable display device of claim 1, wherein the display panel and the optical array panel are at least partially transparent to real-world light originating from a surrounding real-world environment.

3. The head-wearable display device of claim 1, wherein the display panel emits the display light away from the user eye and toward a surrounding real-world environment.

4. The head-wearable display device of claim 3, wherein the display panel is positioned between the user eye and the optical array panel, such that the display light is reflected by the optical array panel toward the user eye, and the display light passes through the display panel en route to the user eye after reflection by the optical array panel.

5. The head-wearable display device of claim 1, wherein the optical array panel is positioned between the display panel and the user eye, and the display panel emits the display light toward the user eye, such that the display light passes through the optical array panel en route to the user eye.

6. The head-wearable display device of claim 1, wherein the display panel includes a plurality of emissive display pixels to emit the display light.

7. The head-wearable display device of claim 6, wherein the display panel includes a micro-organic light emitting diode (μOLED) display.

8. The head-wearable display device of claim 1, wherein the optical array panel includes a micromirror array.

9. The head-wearable display device of claim 1, wherein the optical array panel includes a microlens array.

10. The head-wearable display device of claim 1, wherein the optical array panel includes a metasurface layer.

11. The head-wearable display device of claim 1, wherein the actuator is a microelectromechanical system (MEMS) actuator.

12. The head-wearable display device of claim 1, further comprising a wearable frame assembly sized and shaped for wearing on a human head, the display panel coupled to the wearable frame assembly, and wherein the wearable frame assembly includes a temple support arm.

13. A method for a head-wearable display device, the method comprising:
at a display panel of the head-wearable display device, emitting display light toward an optical array panel via a plurality of emissive display pixels of the display panel, the display panel being at least partially transparent to real-world light originating from a surrounding real-world environment, and the optical array panel configured to redirect the display light toward an eyebox;
estimating a current pupil position of a user eye relative to the head-wearable display device at an eye tracking system of the head-wearable display device; and
translating a position of the optical array panel relative to the display panel to move a position of the eyebox toward the current pupil position of the user eye via an actuator of the head-wearable display device.

14. The method of claim 13, wherein the display panel emits the display light away from the user eye and toward the surrounding real-world environment.

15. The method of claim 14, wherein the display panel is positioned between the user eye and the optical array panel, such that the display light is reflected by the optical array panel toward the user eye, and the display light passes through the display panel en route to the user eye after reflection by the optical array panel.

16. The method of claim 13, wherein the optical array panel is positioned between the display panel and the user eye, and the display panel emits the display light toward the user eye, such that the display light passes through the optical array panel en route to the user eye.

17. The method of claim 13, wherein the display panel includes a micro-organic light emitting diode (μOLED) display.

18. The method of claim 13, wherein the optical array panel includes a micromirror array.

19. The method of claim 13, wherein the actuator is a microelectromechanical system (MEMS) actuator.

20. A computing system, comprising:
an image source to render a display image;
a display panel to emit display light and thereby present the display image for viewing;
an optical array panel positioned along an optical path of the display light emitted by the display panel, the optical array panel configured to redirect the display light toward an eyebox;
a spacer disposed between the display panel and the optical array panel to separate the display panel and the optical array panel by a predetermined separation distance;
an eye tracking system to estimate a current pupil position of a user eye relative to the computing system; and
an actuator to translate a position of the optical array panel relative to the display panel to move a position of the eyebox toward the current pupil position of the user eye.
